(19) United States
(12) Patent Application Publication
(10) Pub. No.: US 2024/0242866 A1
(43) Pub. Date: Jul. 18, 2024

(54) INDUCTOR DEVICE

(71) Applicant: SONY GROUP CORPORATION, TOKYO (JP)

(72) Inventor: NAO AIDA, TOKYO (JP)

(21) Appl. No.: 18/576,133

(22) PCT Filed: Mar. 8, 2022
(86) PCT No.: PCT/JP2022/010023

§ 371 Date: Jan. 3, 2024

(30) Foreign Application Priority Data
Jul. 19, 2021 (JP) 2021-118536

(51) Int. Cl. H01F 3/14; H01F 5/02; H01F 27/29; H02M 3/00

(52) U.S. Cl. CPC H01F 3/14; H01F 5/02; H01F 27/29; H02M 3/01

(57) ABSTRACT

Provided are an inductor device in which a variation in inductance between two magnetically coupled reactors is suppressed, and a DC converter using the inductor device. The inductor device includes a core having a common leg portion, a first leg portion having a first gap, and a second leg portion provided with a second gap in a same positional relationship as the first gap, a first bobbin attached to the first leg portion, a first coil and a second coil separately wound around the first bobbin; a second bobbin attached to the second leg portion and having substantially a same shape as the first bobbin, and a third coil and a fourth coil separately wound around the second bobbin, in which two coils at positions corresponding to an X shape are connected in series in a case where the first coil, the second coil, the third coil, and the fourth coil are viewed from the front.

### TECHNICAL FIELD

The present technology relates to an inductor device having, for example, two inductors.

### BACKGROUND ART

The applicant of the present application has previously proposed the DC converter described in Patent Document 1. FIG. 15 of Patent Document 1 describes a configuration in which two reactors having a converter are magnetically coupled. With this configuration, two reactors can be realized by one inductor device.

### CITATION LIST

### Patent Document

Patent Document 1: WO 2020/208936

### SUMMARY OF THE INVENTION

### Problems to be Solved by the Invention

However, in a case where the two reactors have a separately wound configuration, inductances of the two reactors will vary due to the phenomenon of fringing at the gap. As a result, there is a possibility that the loads of the two converters of the DC converter become unbalanced and a current of an unnecessary frequency component flows in a primary resonance current due to the variation in inductance, thereby generating unnecessary noise.

Consequently, an object of the present technology is to provide an inductor device that suppresses any variation in inductance between two coils separately wound around a common core, and a DC converter using the inductor device.

### Solutions to Problems

The present technology provides an inductor device including:
a core having a common leg portion, a first leg portion having a first gap, and a second leg portion provided with a second gap in a same positional relationship as the first gap;
a first bobbin attached to the first leg portion;
a first coil and a second coil separately wound around the first bobbin;
a second bobbin attached to the second leg portion and having substantially a same shape as the first bobbin; and
a third coil and a fourth coil separately wound around the second bobbin,
in which two coils at positions corresponding to an X shape are connected in series in a case where the first coil, the second coil, the third coil, and the fourth coil are viewed from the front.

### BRIEF DESCRIPTION OF DRAWINGS

FIG. 1 is a connection diagram of a current resonance type converter to which the present technology can be applied.

FIG. 2 is a waveform diagram for describing a drive signal.

FIG. 3 is a mode transition diagram of an operation mode of a switch element according to the present technology.

FIG. 4 is a waveform diagram illustrating a current waveform and a voltage waveform of an element in each operation mode.

FIG. 5 is a waveform diagram illustrating an output current waveform of the present technology.

FIG. 6 is a cross-sectional view of one example of an inductor device.

FIGS. 7A, 7B, and 7C are waveform diagrams respectively illustrating a primary resonance current waveform, an original primary resonance current waveform, and a current difference of a DC converter when there is variation in the inductance of reactors.

FIG. 8 is a graph for describing an influence of variation in the inductance of reactors on a load balance.

FIG. 9 is a cross-sectional view of an inductor device having a bifilar winding configuration.

FIG. 10 is a waveform diagram illustrating a current waveform when the inductor device having a bifilar winding configuration is used.

FIG. 11 is a cross-sectional view of an inductor device according to one embodiment of the present technology.

FIG. 12 is a perspective view of one embodiment of the present technology.

FIG. 13 is an exploded perspective view of one embodiment of the present technology.

FIG. 14 is a connection diagram illustrating a connection of coils according to one embodiment of the present technology.

FIGS. 15A and 15B are a bottom view and a perspective view for describing terminal pins according to one embodiment of the present technology.

FIGS. 16A, 16B, and 16C are schematic diagrams used to describe coil arrangements used in a simulation.

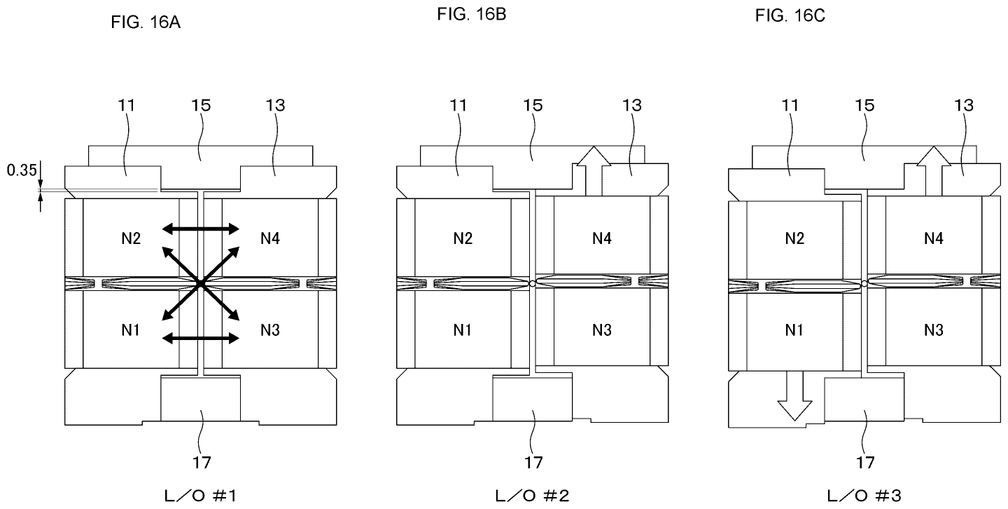

FIGS. 17A and 17B are schematic diagrams used to describe coil arrangements used in a simulation.

### MODE FOR CARRYING OUT THE INVENTION

Hereinafter, embodiments and the like of the present technology will be described with reference to the drawings. Note that the embodiments and the like hereinafter described are preferred specific examples of the present technology, and the contents of the present technology are not limited to the embodiments and the like. Furthermore, in the following description, in order to prevent the illustration from being complicated, only some configurations may be denoted by reference numerals, or some configurations may be illustrated in a simplified manner.

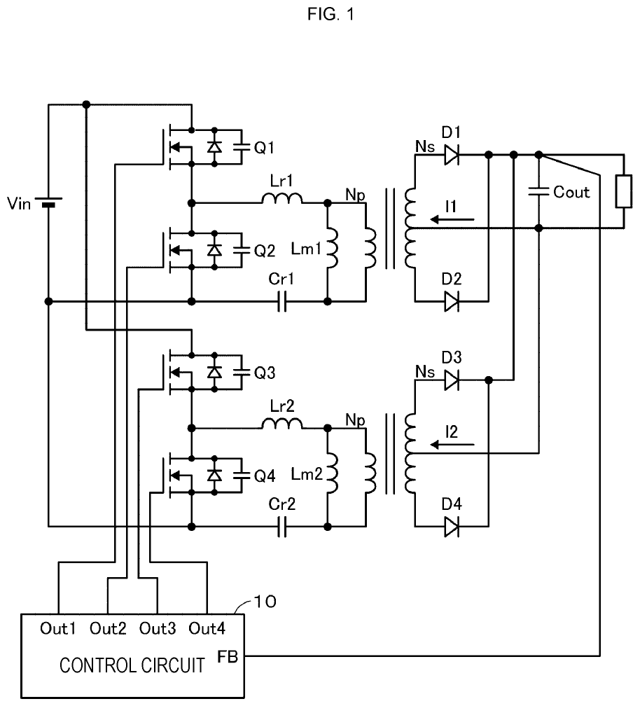

In order to facilitate understanding of one embodiment, the previously proposed DC converter will be described below. This DC converter is a current resonance type (LLC type) converter. In FIG. 1, Vin represents an input power supply, Q1 represents a switch element such as a MOSFET on a high side, and Q2 represents a switch element such as a MOSFET on a low side. A diode and a capacitance are present in parallel as parasitic elements between a drain and a source of the switch element Q1. A diode and a capacitance are present in parallel as parasitic elements between a drain and a source of the switch element Q2. A drive signal is supplied from a control unit to each respective gate of the switch element Q1 and the switch element Q2, and the switch element Q1 and the switch element Q2 perform a switching operation.

A resonance circuit in which a resonance reactor Lr1, a primary winding Np of a transformer, and a resonance capacitance Cr1 are connected in series is connected between a connection point of the source of the switch element Q1 and the drain of the switch element Q2 and the source of the switch element Q2. The reactor Lm1 is connected in parallel to the primary winding Np of the transformer. The reactor Lm1 is, for example, an excitation inductance component of the transformer.

A secondary winding Ns of the transformer is divided into two inductances, and one end of the secondary winding is connected to an output terminal via a diode D1, while the other end of the secondary winding is connected to an output terminal via a diode D2. A connection midpoint of the secondary winding is taken out as the output terminals, and a capacitance Cout is connected between the output terminals. A load is connected to the output terminals. The diode D1, the diode D2, and the capacitance Cout constitute a rectifier that rectifies the voltage generated in the secondary winding of the transformer.

In the above-described converter, drive signals of opposite phases are supplied to the gates of the switch element Q1 and the switch element Q2, and the switch element Q1 and the switch element Q2 perform a switching operation differentially. An output current I1 flows.

The above-described converter is connected in parallel in a pair. The other converter is provided with switch elements Q3 and Q4, reactors Lr2 and Lm2, a resonance capacitance Cr2, a transformer, and diodes D3 and D4. An output current I2 flows through the other converter.

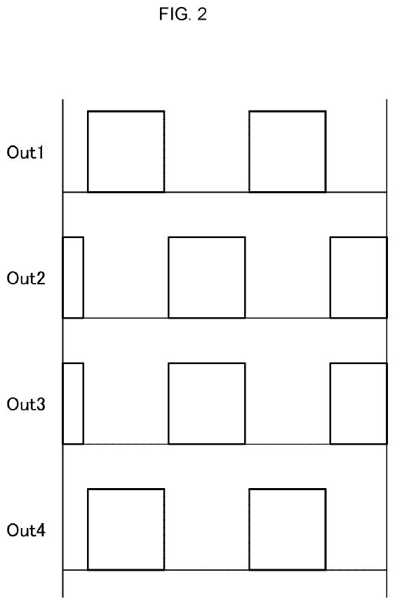

A control circuit 10 is provided, and drive signals Out1, Out2, Out3, and Out4 for controlling on/off of the switch elements Q1 to Q4 of each converter are generated by the control circuit 10. An output voltage output by means of a smoothing circuit is fed back to a feedback FB input of the control circuit 10. The output voltage is controlled at a constant value by means of this feedback. The control circuit 10 controls on/off of the switch elements so as to shift them by n between the two converters. FIG. 2 illustrates the drive signals Out1, Out2, Out3, and Out4 for controlling on/off of the switch elements Q1 to Q4.

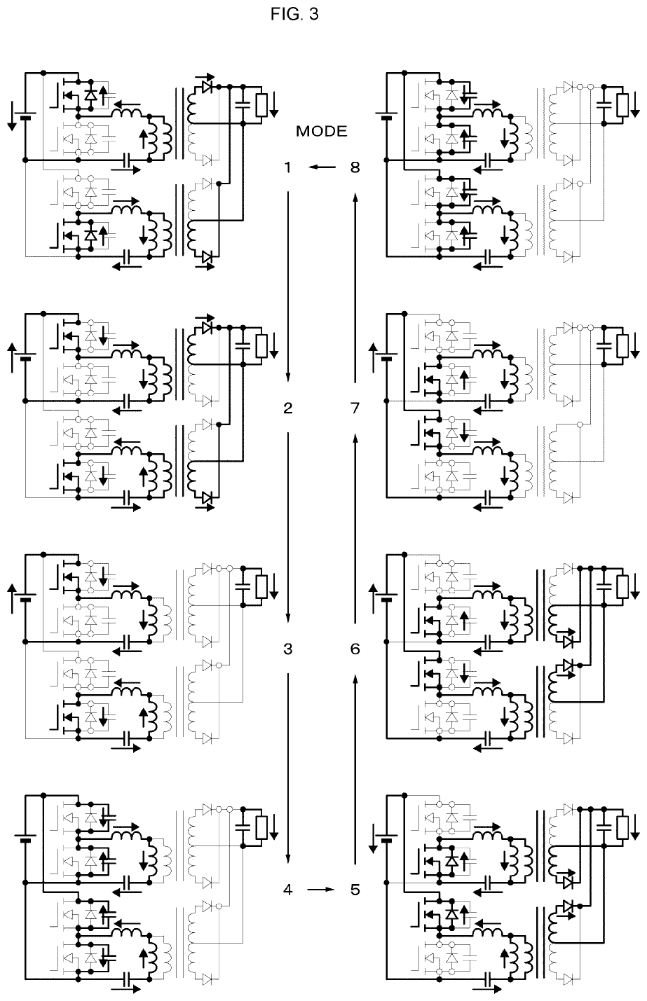

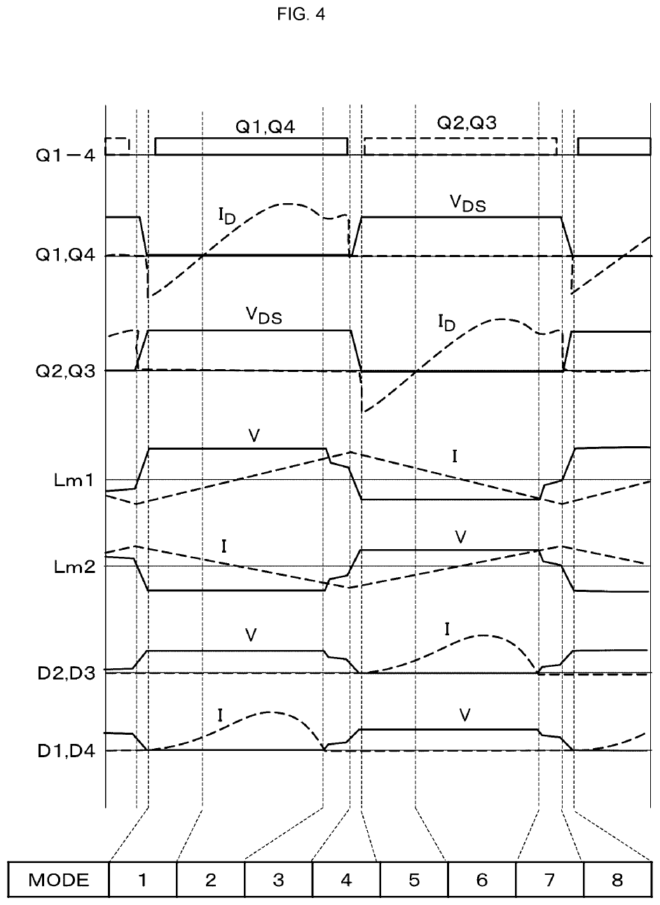

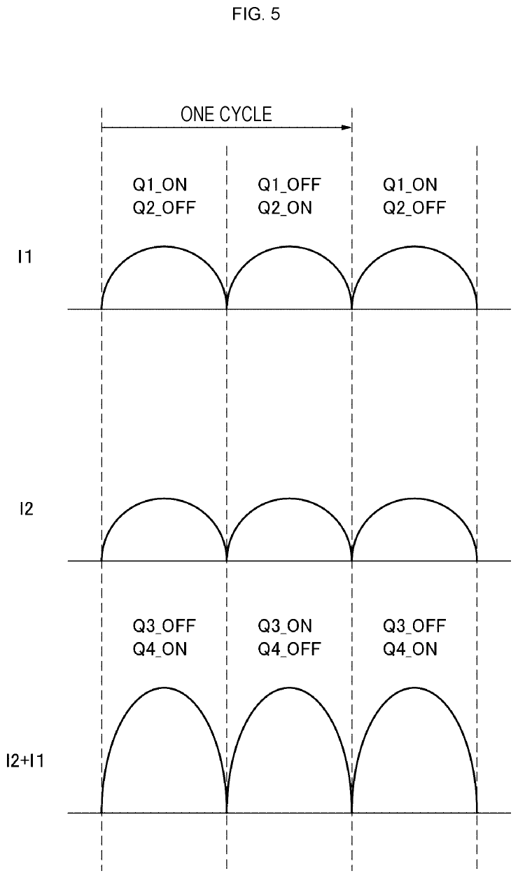

There are eight operation modes (Mode 1, Mode 2, Mode 3, . . . , Mode 8) in accordance with a relationship between the on/off operation of the switch elements Q1 to Q4. FIG. 3 illustrates a current path formed to include switch elements that are turned on in each mode. Furthermore, FIG. 4 shows the voltage and current of each element at that time. The voltage/current waveform in each mode is the same as that of the existing resonance type converter. In the resonance type converter, two switch elements connected in series are alternately turned on/off with a phase difference of n. Since the two converters are operated with the phase difference therebetween of Π, each of Q1 and Q4, and Q2 and Q3, in the drawing are turned on/off simultaneously. Moreover, the output currents I1 and I2 of each respective converter and the output current (I1+I2) calculated by adding both output currents together are as illustrated in FIG. 5.

Each operation mode will be sequentially described. Note that, for simplicity, the source of each switch element Q1 to Q4 is denoted by S, and the drains are denoted by D.

Mode 1: A current flows from S to D of Q1 by means of energy stored in Lm1. Furthermore, a current flows from S to D of Q4 by means of energy stored in Lm2. At this time, a zero-volt switching operation is performed by turning on Q1 and Q4 during conduction of the parasitic diode of each switch element. At the same time, energy is transmitted from a secondary side rectifier to a secondary side.

Mode 2: A current flows from D to S of Q1 by means of an input voltage Vin, and Lm1 is excited to transmit power to the secondary side. Furthermore, a current flows from D to S of Q4 by means of the voltage stored in Cr2, and Lm2 is excited to transmit power to the secondary side.

Mode 3: The voltages at both ends of Lm1 and Lm2 decrease below a value obtained by multiplying the secondary side voltage by the winding number ratio of a transformer, and power transmission to the secondary side is not performed.

Mode 4: Q1 and Q4 are turned off. By means of the energy stored in Lm1, the parasitic capacitance of Q1 is charged, the parasitic capacitance of Q2 is discharged, and the voltage applied to Q1 changes to Vin while the voltage applied to Q2 changes to 0. Similarly, by means of the energy stored in Lm2, the parasitic capacitance of Q4 is charged, the parasitic capacitance of Q3 is discharged, and the voltage applied to Q4 changes to Vin while the voltage applied to Q3 changes to 0.

Mode 5: A current flows from S to D of Q2 by means of the energy stored in Lm1. Furthermore, a current flows from S to D of Q3 by means of the energy stored in Lm2. At this time, a zero-volt switching operation is performed by turning on Q2 and Q3 during conduction of the parasitic diode of each switch element. At the same time, energy is transmitted from a secondary side rectifier to a secondary side.

Mode 6: A current flows from D to S of Q2 by means of the energy stored in Cr1, and Lm1 is excited to transmit power to the secondary side. Furthermore, a current flows from D to S of Q3 from Vin, and Lm2 is excited to transmit power to the secondary side.

Mode 7: The voltages at both ends of Lm1 and Lm2 decrease below a value obtained by multiplying the secondary side voltage by the winding number ratio of the transformer, and power transmission to the secondary side is not performed.

Mode 8: Q1 and Q4 are turned off. By means of the energy stored in Lm1, the parasitic capacitance of Q2 is charged, the parasitic capacitance of Q1 is discharged, and the voltage applied to Q2 changes to Vin while the voltage applied to Q1 changes to 0. Similarly, by means of the energy stored in Lm2, the parasitic capacitance of Q3 is charged, the parasitic capacitance of Q4 is discharged, and the voltage applied to Q3 changes to Vin while the voltage applied to Q4 changes to 0.

The voltage current waveforms of the reactors and the transformer of the resonance type converter illustrated in FIG. 1 have a similar form to the positive/negative inversion with the phase Π. Since the two converters are controlled with the phase difference of Π, the mutual waveforms of the voltages and the currents of the reactors and the transformer have a similar form to the positive and negative inversion. Accordingly, as illustrated in FIG. 1, the reactors and the transformer can be magnetically coupled with their respective polarities reversed.

With this arrangement, reduction of a common mode noise by the two converters can apparently be realized by one reactor or transformer, and an effect can be obtained even in a small-scale DC converter. Furthermore, by magnetically coupling the reactors, balance in operation between the two resonance type converters can be easily achieved.

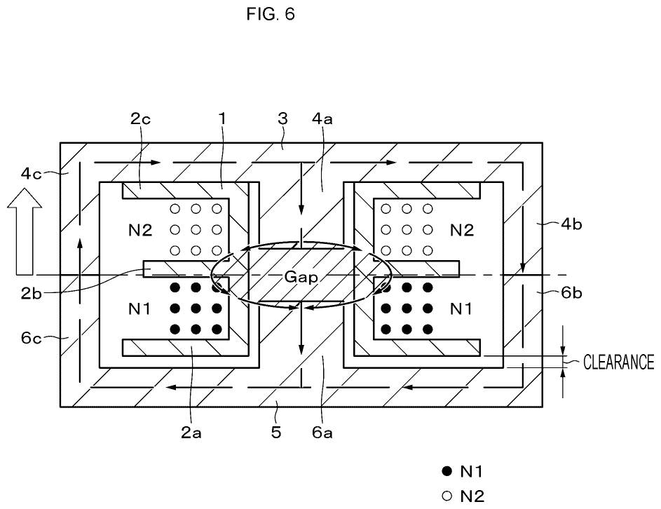

An inductor device according to one embodiment of the present technology is applied to the reactor Lr1 and the reactor Lr2 in the resonance type converter illustrated in FIG. 1. In the reactor, a core (ferrite) having an air gap is used to suppress magnetic saturation. Furthermore, an inductor device having two magnetically coupled reactors is generally configured by means of coils sharing a magnetic path, as illustrated in FIG. 6.

In the example of FIG. 6, a first coil N1 and a second coil N2 are wound around a bobbin 1 having a separator 2a, a separator 2b, a separator 2c, and a circular center hole. The separator 2b is formed at a center position between the separator 2a and the separator 2c. The bobbin 1 is, for example, a resin molded article. The coil N1 is wound between the separator 2a and the separator 2b, and the coil N2 is wound between the separator 2b and the separator 2c. The coil N1 and the coil N2 are separated and wound an equal number of times.

A core 3 and a core 5 having an E-shaped cross section have the same dimensions. Each respective common leg portion 4a and 6a of the core 3 and the core 5 are inserted into the center hole of the bobbin 1, and a gap is formed at a position where both common leg portions 4a and 6a oppose each other. In the gap, the magnetic flux expands in order to make the cross-sectional area through which the magnetic flux passes larger than the cross-sectional area of the core to reduce the magnetic resistance (fringing phenomenon). The magnetic flux generated by this fringing phenomenon is referred to as fringing magnetic flux.

If a center of the separator 2b of the bobbin 1 and a center of the gap are coincident with each other, an influence of the fringing magnetic flux becomes equal to that of the coils N1 and N2. However, a space formed by the core 3 and the core 5 is set to be slightly larger than the bobbin 1, and a clearance is present in a height direction. When the bobbin 1 is assembled by contacting the bobbin 1 with an upper side of the core 3 side as indicated by the arrow in FIG. 6 at the time of assembly to house the bobbin 1, a position of the bobbin 1 deviates from the center of the gap by the amount of clearance.

In this case, the fringing magnetic flux on the coil N1 becomes larger than the fringing magnetic flux on the coil N2 to be (inductance made by the coil N1<inductance made by the coil N2). As described above, in a case where the inductors are configured by the separately winding coils, the position of the bobbin, that is, a position of the coils, cannot be managed, and thus, the inductances of the two inductors varies.

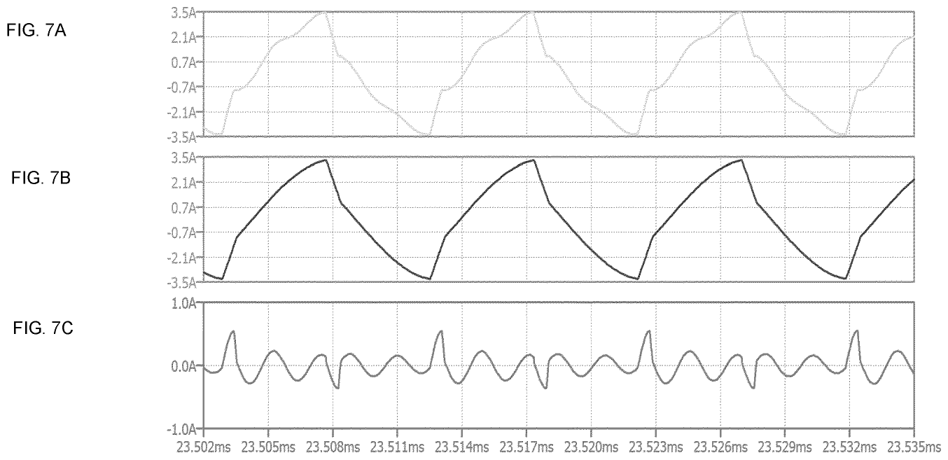

In the case of the DC converter illustrated in FIG. 1, when taking the example of a 10 A, 40 V output, the resonance condition and primary current waveform of each phase are different. FIG. 7A illustrates a primary-side resonance current waveform in a case where the inductance ratio varies by 2%. FIG. 7B illustrates the primary-side resonance current waveform in a case where there is no variation in inductance ratio. The primary-side resonance current waveform illustrated in FIG. 7A has a difference component, as illustrated in FIG. 7C, from the primary-side resonance current waveform illustrated in FIG. 7B. There has been a possibility that the difference component would cause the generation of unnecessary noise or the generation of an imbalance in circuit load.

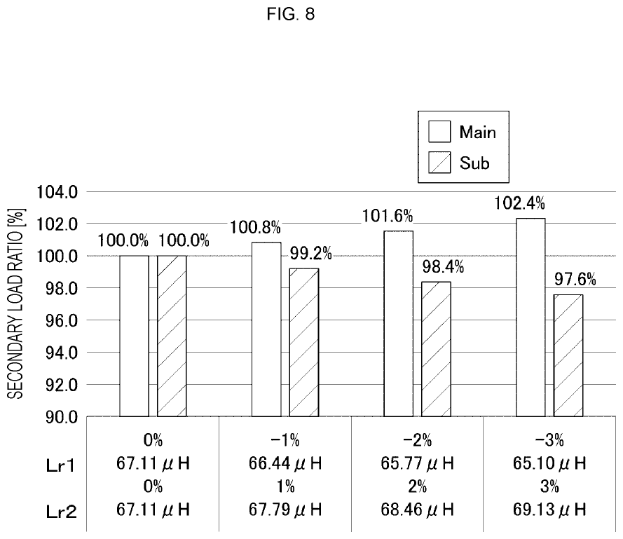

FIG. 8 illustrates a relationship between a variation in inductance and a variation in load of the reactors Lr1 and Lr2. In a case where the inductance of each inductor is 67.11 μH (variation is 0%), the secondary load ratios are both 100%. In FIG. 8, the white bar indicates the secondary load ratio of the converter including the reactor Lr1, and the shaded bar indicates the secondary load ratio of the converter including the reactor Lr2. Usually, in a case where an inductor device is manufactured by moving the bobbin 1 to one side, the inductance difference is +/−3%. As illustrated in FIG. 8, in a case where the inductance difference is +/−1%, the load current changes by +/−0.8%, in a case where the inductance difference is +/−2%, the load current changes by +/−1.6%, and in a case where the inductance difference is +/−3%, the load current changes by +/−2.4%. Since the load variation has a relationship of (inductance difference×0.8) as described above, in a case where the inductance difference is +/−3%, the load variation is +/−2.4%.

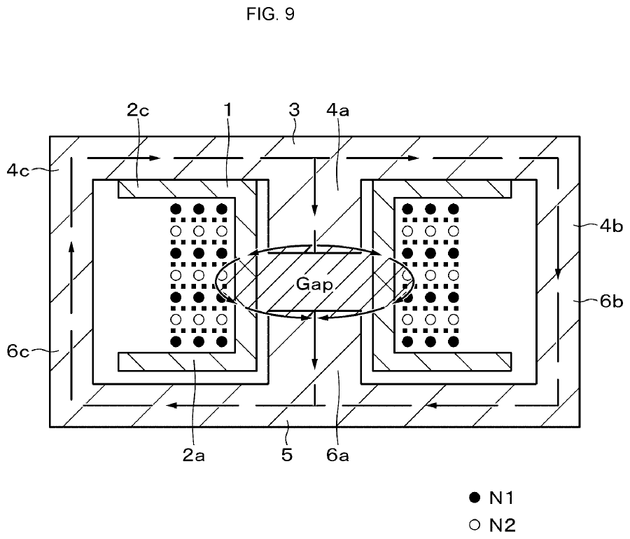

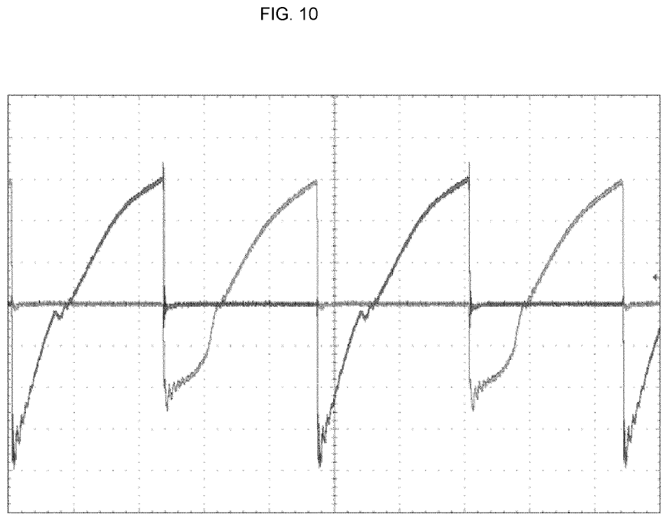

In order to eliminate the variation in inductance, bifilar winding the two coils N1 and N2, as illustrated in FIG. 9, is considered. That is, a method of alternately winding the two coils N1 and N2 as one pair between the separator 2a and the separator 2c of the bobbin 1 is considered. In this method, since the coil N1 and the coil N2 are in close contact with each other, there is a problem in that the parasitic capacitance generated in the dashed line portion in FIG. 9 increases. The line-to-line capacitance is about 10 times that of the separate winding illustrated in FIG. 6. Because of the line-to-line capacitance, a problem occurs in that the current waveform becomes unbalanced, as illustrated in FIG. 10.

The relationships between combinations of variations in the resonance capacitors Cr1 and Cr2, the reactors Lr1 and Lr2, and the primary current and the secondary current are illustrated in Table 1 below. The notation Main represents the converter or the reactor Lr1 configured by the switch elements Q1 and 02 and the notation Sub represents the converter or the reactor Lr2 configured by the switch elements Q3 and 04 (see FIG. 1). Furthermore, in Table 1, a horizontally long table is divided into four tables and arranged vertically, and each row of the divided tables corresponds to each other. The variation of the resonance capacitors is set as +/−3% as one example.

TABLE 1
Resonance capacitor

| | |
|---|---|
| Main | Sub |

| | | | |
|---|---|---|---|
| 0.05562 μF | 3% | 0.05238 μF | −3% |
| 0.05562 μF | 3% | 0.05238 μF | −3% |
| 0.05562 μF | 3% | 0.05238 μF | −3% |
| 0.05562 μF | 3% | 0.05238 μF | −3% |

Divided L

| | | |
|---|---|---|
| Main | Sub | Coupled |

| | | | | |
|---|---|---|---|---|
| 67.11 μH | 0% | 67.11 μH | 0% | 0.7 |
| 67.79 μH | 1% | 66.44 μH | −1% | 0.7 |
| 68.46 μH | 2% | 65.77 μH | −2% | 0.7 |
| 69.13 μH | 3% | 65.10 μH | −3% | 0.7 |

Primary current

| Main | Sub | Main | Sub |
|---|---|---|---|
| 4.075 Arms | 3.813 Arms | 103.3% | 96.7% |
| 4.101 Arms | 3.789 Arms | 104.0% | 96.0% |
| 4.127 Arms | 3.766 Arms | 104.6% | 95.4% |
| 4.151 Arms | 3.742 Arms | 105.2% | 94.8% |

Secondary current

| Main | Sub | Main | Sub |
|---|---|---|---|
| 9.374 A | 8.628 A | 104.1% | 95.9% |
| 9.444 A | 8.557 A | 104.9% | 95.1% |
| 9.520 A | 8.492 A | 105.7% | 94.3% |
| 9.590 A | 8.423 A | 106.5% | 93.5% |

In practical use, it is desirable to set the load balance to within +/−5%. In Table 1, it is necessary to set the variation of the secondary current to (104.9%:95.1%), and to do this, it is necessary to set the variation of the reactors Lr1 and Lr2 to +/−18. In order to set the variation of the reactors to within this range, an assembly accuracy of, for example, 0.2 (mm) or less is required. However, in terms of specifications and manufacturing, it has been practically impossible to reliably attach the bobbin to the core with this level of accuracy in assembly.

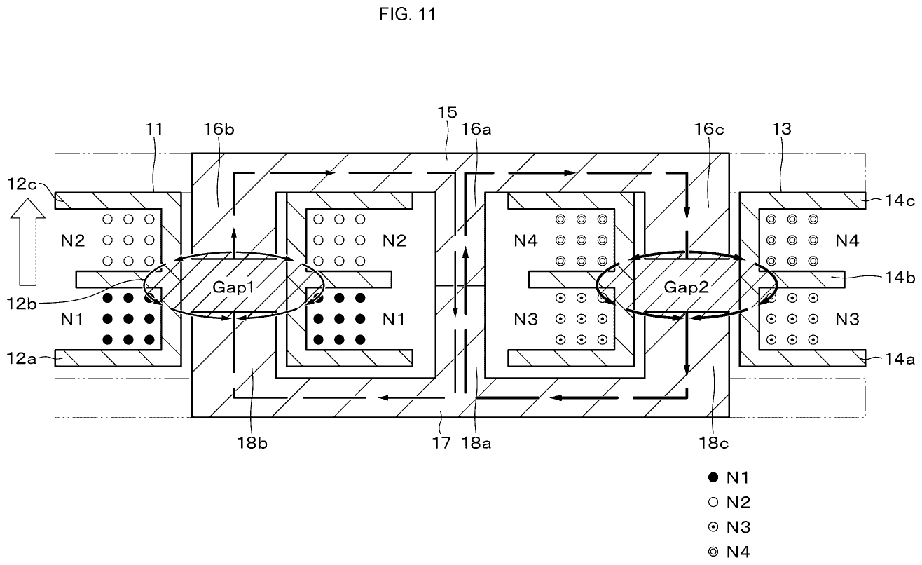

One embodiment of the present technology for solving the above-described problem in the conventional inductor device will be described. FIG. 11 is a cross-sectional view for describing one embodiment of the present technology. First coil N1 and second coil N2 are separately wound around a bobbin 11 as a first bobbin. The bobbin 11 includes a separator 12a, a separator 12b, and a separator 12c each having a ring shape on a peripheral surface of a cylindrical body. The separator 12b is formed at a central position between the separator 12a and the separator 12c. The bobbin 11 is, for example, a resin molded article. The coil N1 is wound between the separator 12a and the separator 12b, while the coil N2 is wound between the separator 12b and the separator 12c.

A third coil N3 and a fourth coil N4 are separately wound around a bobbin 13 as a second bobbin. The bobbin 13 includes a separator 14a, a separator 14b, and a separator 14c each having a ring shape on a peripheral surface of a cylindrical body. The separator 14b is formed at a central position between the separator 14a and the separator 14c. The bobbin 13 is, for example, a resin molded article. The coil N3 is wound between the separator 14a and the separator 14b, while the coil N4 is wound between the separator 14b and the separator 14c. The coils N1, N2, N3, and N4 contain a wire material of the same type and the same size, and are each wound the same number of times.

The bobbin 11 and the bobbin 13, around each of which the coils are wound, are attached to a core 15 and a core 17. The core 15 and the core 17 are, for example, ferrite cores. The core 15 has an E-shaped cross section, and integrally includes a central common leg portion 16a and leg portions 16b and 16c provided at symmetrical positions on outer sides of the common leg portion 16a. The core 17 has the same shape as the core 15, and integrally includes a central common leg portion 18a and leg portions 18b and 18c provided at symmetrical positions on outer sides of the common leg portion 18a.

An end surface of the common leg portion 16a of the core 15 and an end surface of the common leg portion 18a of the core 17 contact each other, an end surface of the leg portion 16b of the core 15 and an end surface of the leg portion 18b of the core 17 face each other with a first gap interposed therebetween, and an end surface of the leg portion 16c of the core 15 and an end surface of the leg portion 18c of the core 17 face each other with a second gap interposed therebetween. The widths of these gaps are assumed to be equal.

The leg portion 16b of the core 15 and the leg portion 18b of the core 17 are inserted into a center hole of the bobbin 11, and the leg portion 16c of the core 15 and the leg portion 18c of the core 17 are inserted into a center hole of the bobbin 13. FIG. 11 is a view of the first coil N1, the second coil N2, the third coil N3, and the fourth coil N4 of the inductor device as seen from the front. In FIG. 11, two coils (N1 and N4, and N2 and N3) at positions corresponding to an X shape (crisscross) are connected in series.

In a case where inductances formed by each of the coils N1, N2, N3, and N4 are respectively expressed as L1, L2, L3, and L4, L1≈L3 and L2≈L4 in a case where the inductances are influenced by fringing magnetic flux. Consequently, the inductances of the coils N1 and N4 connected in series are (L1+L4), while the inductances of the coils N2 and N3 connected in series are (L2+L3). Accordingly, (L1+L4≈L2+L3).

The values of the inductances (L1+L4) are set to be equal to the value of the reactor Lr1 in the DC converter illustrated in FIG. 1, while the values of the inductances (L2+L3) are set to be equal to the value of the reactor Lr2 in the DC converter illustrated in FIG. 1. Consequently, the variation of the reactors Lr1 and Lr2 caused by fringing magnetic flux can be suppressed.

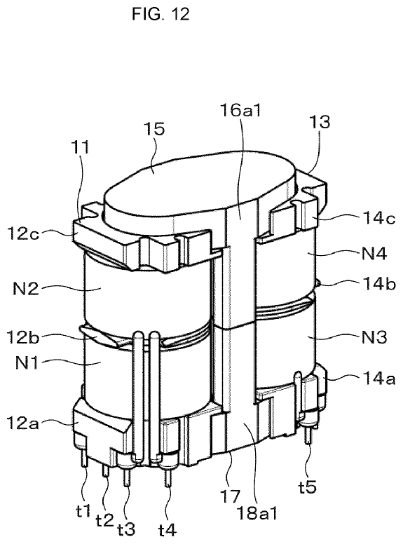

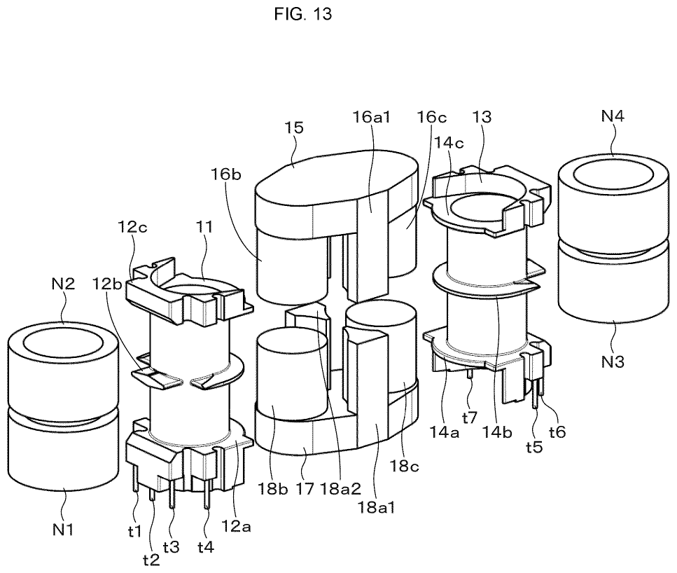

FIG. 12 is a perspective view of one embodiment of the present technology, and FIG. 13 is an exploded perspective view of one embodiment of the present technology. Although the coils N1 to N4 are drawn as cylindrical surfaces in the drawings, the wire material is wound a predetermined number of times. Terminal pins t1, t2, t3, and t4 protrude from a lower portion of the cylindrical-shaped bobbin 11 including the separator 12a, the separator 12b, and the separator 12c. Terminal pins t5, t6, t7, and t8 protrude from a lower portion of the cylindrical-shaped bobbin 13 including the separator 14a, the separator 14b, and the separator 14c. Ends of the coils N1 to N4 are connected to the terminal pins t1 to t8. The bobbin 11 and the bobbin 13 are mounted such that longitudinal directions thereof are vertical relative to a printed circuit board. The terminal pins penetrate the printed circuit board and are connected to a wiring pattern on the printed circuit board.

The leg portion 16b of the core 15 and the leg portion 18b of the core 17 have a columnar shape that is inserted into the center hole of the bobbin 11. The leg portion 16c of the core 15 and the leg portion 18c of the core 17 have a columnar shape that is inserted into the center hole of the bobbin 13. The common leg portion 16a of the core 15 is configured by divided common leg portions 16a1 and 16a2, while the common leg portion 18a of the core 17 is configured by divided common leg portions 18a1 and 18a2.

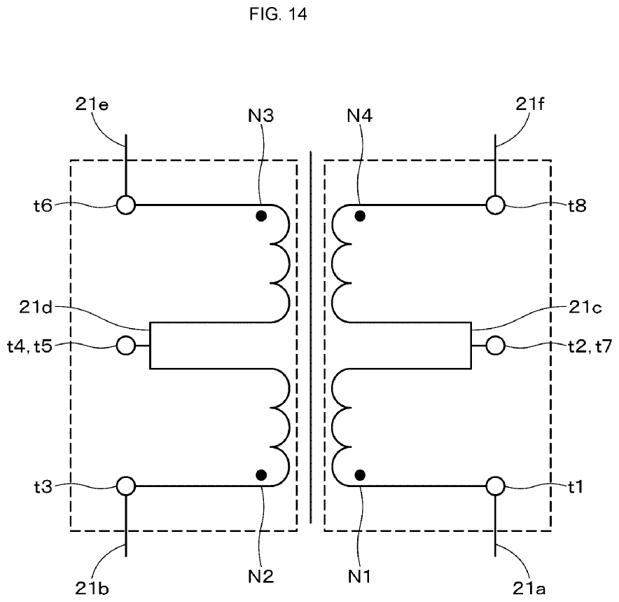

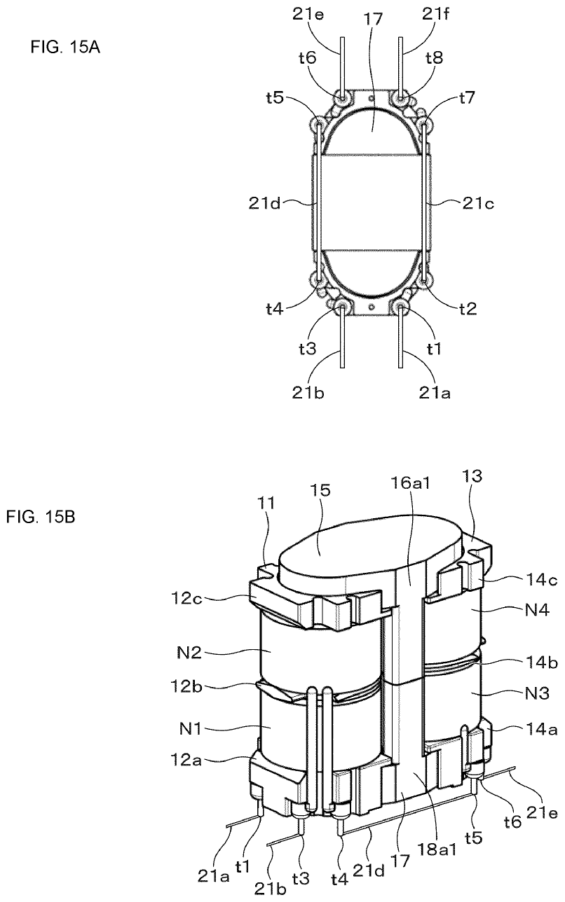

As illustrated in FIGS. 14, 15A, and 15B, the coils N1 to N4 are connected by the terminal pins t1 to t8. One end of the coil N1 (the black dot indicates a winding start side (polarity)) is connected to the terminal pin t1, and the terminal pin t1 is connected to a wiring pattern 21a of the printed circuit board (not illustrated). The other end of the coil N1 is connected to the terminal pin t2, the terminal pin t2 is connected to a wiring pattern 21c of the printed circuit board (not illustrated), and the terminal pin t7 is connected to the wiring pattern 21c. The other end of the coil N4 is connected to the terminal pin t7. One end of the coil N4 (the black dot indicates a winding start side (polarity)) is connected to a wiring pattern 21f. In this manner, the coil N1 and the coil N4 are connected in series.

The coil N2 and the coil N3 are connected in series in a similar way. One end of the coil N2 (black dot side) is connected to the terminal pin t3, and the terminal pin t3 is connected to a wiring pattern 21b of the printed circuit board (not illustrated). The other end of the coil N2 is connected to the terminal pin t4, the terminal pin t4 is connected to a wiring pattern 21d of the printed circuit board (not illustrated), and the terminal pin t5 is connected to the wiring pattern 21d. The other end of the coil N3 is connected to the terminal pin t5. One end of the coil N3 (black dot side) is connected to a wiring pattern 21e. In this manner, the coil N2 and the coil N3 are connected in series. Since the inductor device is mounted vertically, it is possible to prevent the wiring patterns from crossing over each other.

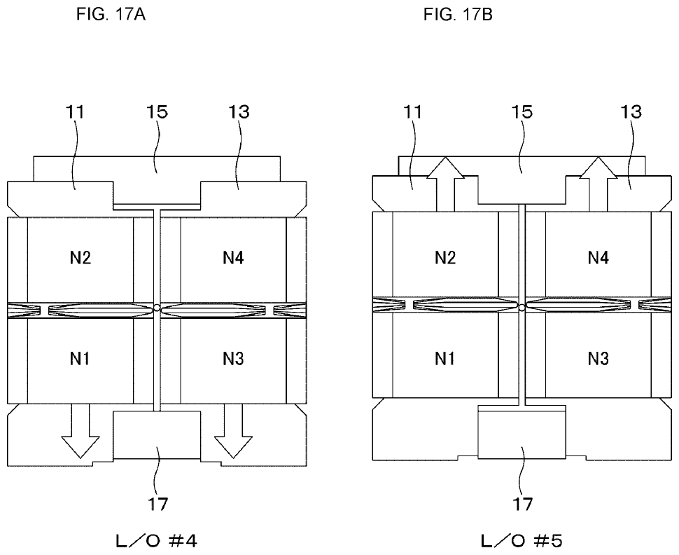

The series connection of the coil N1 and the coil N4 connected in series corresponds to the reactor Lr1 in the DC converter illustrated in FIG. 1, while the series connection of the coil N2 and the coil N3 connected in series corresponds to the reactor Lr2 in the DC converter illustrated in FIG. 1. With respect to the above-described one embodiment of the present technology, layouts of the coils N1 to N4 (denoted as L/O in FIG. 17 and FIG. 17) and simulation results of variations in inductance will be described with reference to FIG. 17, FIG. 17, and Table 2.

TABLE 2

| Combination | L/O#1 | L/O#2 | L/O#3 | L/O#4 | L/O#5 |
|---|---|---|---|---|---|
| N1-N3 series | 55.922 | 55.438 | 55.909 | 56.817 | 55.009 |
| N2-N4 series | 56.941 | 56.402 | 55.932 | 55.070 | 56.782 |
| N1-N4 series | 65.923 | 56.341 | 56.789 | 55.937 | 58.893 |
| N2-N3 series | 55.940 | 55.499 | 55.052 | 55.950 | 55.898 |

Table 2 shows the inductance (H) of series connections of the two coils in each layout. As examples of the series connections, the respective inductances of a series connection of the coil N1 and the coil N3 (denoted as (N1-N3 series), a series connection of the coil N2 and the coil N4 (denoted as (N2-N4 series), a series connection of the coil N1 and the coil N4 (denoted as (N1-N4 series), and a series connection of the coil N2 and the coil N3 (denoted as (N2-N3 series) were required. The above-described one embodiment of the present technology is a configuration of (N1-N4 series) and (N2-N3 series), while another connection in which the coils on an upper side and the coils on a lower side are connected in series is a configuration for comparison. Furthermore, in the simulation, a clearance in a height direction between the cores 15 and 17 and the bobbins 11 and 13 is set to (0.35 (mm)) on one side. Each layout will be described.

Layout #1: A layout in which the bobbin 11 and the bobbin 13 are located at the center (clearance=0). In the layout #1, the ratio of the difference between the inductances of the two series connections (N1-N3 series) and (N2-N4 series) is 0%, and the ratio of the difference between the inductances of the other two series connections (N1-N4 series) and (N2-N3 series) is also 0%.

Layout #1 illustrated in FIG. 17A: A layout in which the bobbin 11 and the bobbin 13 are arranged at the center (clearance=0). In the layout #1, the ratio of the difference between the inductances of the two series connections (N1-N3 series) and (N2-N4 series) is 0%, and the ratio of the difference between the inductances of the other two series connections (N1-N4 series) and (N2-N3 series) is also 0%.

Layout #2 illustrated in FIG. 17B: A layout in which the bobbin 11 is arranged at the center and the bobbin 13 is mated to an upper side. In the layout #1, the ratio (56.402−55.438)/55.438) of the difference between the inductances of the two series connections (N1-N3 series) and (N2-N4 series) is −1.7%. The ratio (56.341−55.499)/56.341) of the difference between the inductances of the other two series connections (N1-N4 series) and (N2-N3 series) is 1.5%.

Layout #3 illustrated in FIG. 17C: A layout in which the bobbin 11 is mated to a lower side and the bobbin 13 is mated to the upper side. In the layout #3, the ratio (55.909−55.932)/55.909) of the difference between the inductances of the two series connections (N1-N3 series) and (N2-N4 series) is 0%. The ratio (56.789−55.052)/56.789) of the difference between the inductances of the other two series connections (N1-N4 series) and (N2-N3 series) is 3.1%.

Layout #4 illustrated in FIG. 17A: A layout in which the bobbin 11 and the bobbin 13 are mated to the lower side. In the layout #4, the ratio (56.817−55.070)/56.817) of the difference between the inductances of the two series connections (N1-N3 series) and (N2-N4 series) is 3.1%. The ratio (55.937−55.950)/55.937) of the difference between the inductances of the other two series connections (N1-N4 series) and (N2-N3 series) is 0%. Consequently, the configuration of the present technology can further reduce the variation in inductance.

Layout #5 illustrated in FIG. 17B: A layout in which the bobbin 11 and the bobbin 13 are mated to the upper side. In the layout #5, the ratio (55.009−56.782)/55.009) of the difference between the inductances of the two series connections (N1-N3 series) and (N2-N4 series) is −3.2%. The ratio (55.893−55.898)/55.893) of the difference between the inductances of the other two series connections (N1-N4 series) and (N2-N3 series) is 0%. Consequently, the configuration of the present technology can further reduce the variation in inductance.

Consequently, the layout #4 or the layout #5 assembled so as to displace both of the bobbin 11 and the bobbin 13 in the same direction to abut against one of the first core 15 and the second core 17 can suppress the variation in inductance.

The above-described one embodiment of the present technology can exhibit the following effects.

An installation floor area can be reduced by using a magnetic circuit shared core.

It is possible to realize a coupled reactor in which the variation in inductance can be minimized.

It is no longer necessary to combine inductances on a circuit side by rank, thus management costs can be reduced.

It is possible to reduce load imbalance between the two converters of the DC converter.

It is possible to suppress the generation of unnecessary noise from an unnecessary frequency component current flowing in the primary resonance current due to the variation in inductance.

Although one embodiment of the present technology is heretofore described specifically, the present technology is not limited to the above-described one embodiment, and various modifications based on the technical idea of the present technology may be made. Furthermore, the configuration, method, step, shape, material, numerical value and the like described in the above-described embodiment are illustrative only, and the configuration, method, step, shape, material, numerical value and the like different from those may also be used as necessary.

The present technology can have the following configurations.
(1)
An inductor device including:
a core including a common leg portion, a first leg portion having a first gap, and a second leg portion provided with a second gap in a same positional relationship as the first gap;
a first bobbin attached to the first leg portion;
a first coil and a second coil separately wound around the first bobbin;
a second bobbin attached to the second leg portion and having substantially a same shape as the first bobbin; and
a third coil and a fourth coil separately wound around the second bobbin,
in which two coils at positions corresponding to an X shape are connected in series in a case where the first coil, the second coil, the third coil, and the fourth coil are viewed from the front.
(2)
The inductor device according to claim 1, in which each of the first bobbin and the second bobbin has a first separator, a second separator, and a third separator each protruding from both end portions and a central portion of a cylindrical body,
the first coil is wound between the first separator and the second separator of the first bobbin,
the second coil is wound between the second separator and
the third separator of the first bobbin, the third coil is wound between the first separator and the second separator of the second bobbin,
the fourth coil is wound between the second separator and the third separator of the second bobbin, and
inductances formed by each of the first coil, the second coil, the third coil, and the fourth coil are made substantially equal to each other.
(3)
The inductor device according to (1) or (2), in which the first coil and the fourth coil are connected in series, and the second coil and the third coil are connected in series.
(4)
The inductor device according to (3), in which a first terminal pin and a second terminal pin connected to both ends of the first coil and a third terminal pin and a fourth terminal pin connected to both ends of the second coil are provided at a lower portion of the first bobbin,
a fifth terminal pin and a sixth terminal pin connected to both ends of the third coil and a seventh terminal pin and an eighth terminal pin connected to both ends of the fourth coil are provided at a lower portion of the second bobbin,
the first coil and the fourth coil are connected in series by connecting the second terminal pin and the seventh terminal pin by a wiring pattern of a printed circuit board, and
the second coil and the third coil are connected in series by connecting the fourth terminal pin and the fifth terminal pin by a wiring pattern of a printed circuit board.
(5)
The inductor device according to any one of (1) to (3), in which a clearance is present in a height direction of each of an attachment position of the first bobbin relative to the first leg portion and an attachment position of the second bobbin relative to the second leg portion, and
the first bobbin and the second bobbin are assembled so as to be displaced in a same direction to abut against one of the first core and the second core.
(6)
The inductor device according to any one of (1) to (3), in which the first bobbin and the second bobbin are mounted such that longitudinal directions thereof are vertical relative to a printed circuit board.

### REFERENCE SIGNS LIST

Q1, Q2, Q3, Q4 Switch element
10 Control circuit
Lr1, Lr2 resonance reactor
Cr1, Cr2 resonance capacitance
1, 11, 13 Bobbin
3, 5, 15, 17 Core
4a, 6a, 16a, 16a1, 16a2, 18a, 18a1, 18a2 Common leg portion
4b, 4c, 6b, 6c, 16b, 16c, 18b, 18c Leg portion
N1, N2, N3, N4 Coil

1. An inductor device comprising:
a core including a common leg portion, a first leg portion having a first gap, and a second leg portion provided with a second gap in a same positional relationship as the first gap;
a first bobbin attached to the first leg portion;
a first coil and a second coil separately wound around the first bobbin;
a second bobbin attached to the second leg portion and having substantially a same shape as the first bobbin; and
a third coil and a fourth coil separately wound around the second bobbin,
wherein two coils at positions corresponding to an X shape are connected in series in a case where the first coil, the second coil, the third coil, and the fourth coil are viewed from the front.

2. The inductor device according to claim 1, wherein each of the first bobbin and the second bobbin has a first separator, a second separator, and a third separator each protruding from both end portions and a central portion of a cylindrical body,
the first coil is wound between the first separator and the second separator of the first bobbin,
the second coil is wound between the second separator and the third separator of the first bobbin,
the third coil is wound between the first separator and the second separator of the second bobbin,
the fourth coil is wound between the second separator and the third separator of the second bobbin, and
inductances formed by each of the first coil, the second coil, the third coil, and the fourth coil are made substantially equal to each other.

3. The inductor device according to claim 1, wherein the first coil and the fourth coil are connected in series, and the second coil and the third coil are connected in series.

4. The inductor device according to claim 3, wherein a first terminal pin and a second terminal pin connected to both ends of the first coil and a third terminal pin and a fourth terminal pin connected to both ends of the second coil are provided at a lower portion of the first bobbin,
a fifth terminal pin and a sixth terminal pin connected to both ends of the third coil and a seventh terminal pin and an eighth terminal pin connected to both ends of the fourth coil are provided at a lower portion of the second bobbin,
the first coil and the fourth coil are connected in series by connecting the second terminal pin and the seventh terminal pin by a wiring pattern of a printed circuit board, and
the second coil and the third coil are connected in series by connecting the fourth terminal pin and the fifth terminal pin by a wiring pattern of a printed circuit board.

5. The inductor device according to claim 1, wherein a clearance is present in a height direction of each of an attachment position of the first bobbin relative to the first leg portion and an attachment position of the second bobbin relative to the second leg portion, and
the first bobbin and the second bobbin are assembled so as to be displaced in a same direction to abut against one of the first core and the second core.

6. The inductor device according to claim 1, wherein the first bobbin and the second bobbin are mounted such that longitudinal directions thereof are vertical relative to a printed circuit board.
